(19) United States
(12) Patent Application Publication
(10) Pub. No.: US 2010/0286463 A1
(43) Pub. Date: Nov. 11, 2010

(54) Process and Apparatus for the Pyrolytic Conversion of Organic Halides to Hydrogen Halides

(75) Inventor: Gregorio Tarancon, III, Fort Myers, FL (US)

Correspondence Address: BRACEWELL & GIULIANI LLP, P.O. BOX 61389, HOUSTON, TX, 77208-1389, US

(73) Assignee: Ideal Fluids, Inc., Fort Myers, FL (US)

(21) Appl. No.: 12/576,793

(22) Filed: Oct. 9, 2009

Related U.S. Application Data
(60) Provisional application No. 61/176,220, filed on May 7, 2009.

(51) Int. Cl. A62D 3/37; A62D 101/22; B01J 19/00

(52) U.S. Cl. 588/319; 422/198

(57) ABSTRACT

A process for the conversion of organic halide compounds, including refrigerant fluids, is provided. The process includes contacting the organic halide compound with an additive hydrogen donor at a reaction temperature, to produce a product stream that includes a hydrogen halide and carbon oxide.

### RELATED APPLICATIONS

This application claims priority to U.S. Provisional Patent Application Ser. No. 61/176,220, filed on May 7, 2009, which is incorporated by reference in its entirety.

### FIELD OF THE INVENTION

This invention relates to a process and apparatus for the conversion of organic halides, such as perfluorocarbon fluids and refrigerant fluids, for the environmentally safe disposal thereof.

### BACKGROUND OF THE INVENTION

In the 20^{th} century, the synthesis of a significant number of organic halide fluids was accomplished, including the majority of refrigerant fluids such as clorofluorocarbons (hereinafter “CFCs”), hydrochlorofluorocarbons (“HCFCs”), fluorocarbons (“FCs”) and hydrofluorocarbons (“HFCs”). Prior to the 20^{th} century, it was disclosed that metallic elements can be oxidized in the presence of an oxidizer such as oxygen or fluorine; some of them naturally occurring such as in the case of calcium metal that naturally form calcium carbonate and calcium fluoride and aluminum metal that naturally form aluminum oxide and aluminum fluoride.

It has been established that some organic halides, particularly compounds used as refrigerants, have contributed to the depletion of ozone in the atmosphere, and international action has been taken to phase out their use. Currently, the scientific community is concerned with protecting the environment, particularly with respect to any chemical contamination, including the release of carbon dioxide to the atmosphere.

Current methods for the treatment and/or destruction of organic halides and refrigerant waste can include the use of extremely high temperatures. For example, certain methods for the destruction of Freon include heating the compounds to a temperature of about 1300° C. under reducing conditions. Thus, there exists a need for methods for the treatment of organic halides under less severe conditions.

### SUMMARY

The current invention provides an improved method and apparatus for the conversion of organic halides to hydrogen halides.

In one aspect, a method for treating organic halides is provided. The method includes the steps of contacting an organic halide and a hydrogen donor in a reaction zone, wherein the reaction zone is maintained at a reaction zone temperature that is greater than the critical temperature of the organic halide, and collecting a product stream that includes a hydrogen halide and a carbon oxide.

In another aspect, an apparatus for the thermal conversion of organic halides is provided. The apparatus includes a mixing apparatus for providing a fluid mixture, wherein the mixer includes an inlet for an organic halide fluid stream, an inlet for a hydrogen donor additive fluid stream, and means for mixing said fluid streams to provide the fluid mixture. The apparatus further includes a heat exchanger for heating the fluid mixture, and a reaction chamber for reacting the organic halide and the hydrogen donor additive to produce a product stream that includes a hydrogen halide. The reaction chamber further includes an inlet for receiving the fluid mixture and an outlet for providing a product stream, and also includes means for transferring heat within the reaction chamber. The apparatus further includes means for measuring and controlling the temperature within the reaction chamber; and a receiver for collecting the product stream from said reaction chamber.

### BRIEF DESCRIPTION OF THE DRAWINGS

FIG. 1 is a diagram of one embodiment of an apparatus for use according to the present invention.

### DETAILED DESCRIPTION OF THE INVENTION

Although the following detailed description contains many specific details for purposes of illustration, it is understood that one of ordinary skill in the art will appreciate that many examples, variations and alterations to the following details are within the scope and spirit of the invention. Accordingly, the exemplary embodiments of the invention described herein are set forth without any loss of generality to, and without imposing limitations thereon, the claimed invention.

In one aspect, the present invention provides a method for effecting the thermochemical conversion of organic halides and waste refrigerants, by reaction with a hydrogen donor additive to a hydrogen halide, at much milder conditions than those that are typically employed for the treatment or destruction of organic halides.

According to one aspect of the present invention, the organic halide compounds, such as CFC, HCFC, FC, HFC, whether pure or as a mixture of two or more organic halides, are treated as waste organic halide fluids, and can be converted to a hydrogen halide and carbon oxide, thereby converting the organic halide to an intermediate chemical compound for further use. In one embodiment, the conversion of the organic halide to a hydrogen halide can be achieved with the assistance of an additive hydrogen donor.

Organic halide compounds and/or waste refrigerants fluids can include CFCs, HCFCs, FCs, and HFCs, that include at least of one fluid compound, such as refrigerant fluids including, but not limited to: R10 (carbontetrachloride), R11 (trichlorofluoromethane), R12 (dichlorodifluoromethane), R13 (chlorotrifluoromethane), R14 (tetrafluoromethane), R21 (dichlorofluoromethane), R22 (chlorodifluoromethane), R23 (trifluoromethane), R30 (methylene chloride), R31 (chlorofluoromethane), R32 (dichloromethane), R40 (chloromethane), R41 (fluoromethane), R152a (difluoroethane), R110 (chloroethane), R112 (chlorodifluoroethane), R113 (trichlorotrifluoroethane), R114 (dichlorotetrafluoroethane), R115 (chloropentafluoroethane), R116 (hexafluoroethane), R123 (dichlorotrifluoroethane), R124 (chlorotetrafluoroethane), R125 (pentafluoroethane), R134a (tetrafluoroethane), R141b (dichlorofluoroethane), R142b (chlorodifluoroethane), R143a (trifluoroethane), and like compounds. Similarly, brominated refrigerants, such as R12B (bromochlorodifluoromethane) and R13B (bromotrifluoromethane), and other related compounds having one or two carbon atoms and at least one bromine atom, can be treated according to the methods described herein. As used herein a fluid is defined as any substance, (liquid, gas, or plasma) that has a low resistance to flow and that tends to assume the shape of its container. As used herein, organic halide refers to molecules that include both carbon and a halogen, preferably including between 1 and 2 carbon atoms, and at least one halogen atom per molecule. In certain embodiments, the organic halide and/or waste refrigerant includes at least one carbon atom and at least one fluorine atom.

The conversion of organic halide fluids to hydrogen halides can be can include the use of an additive hydrogen donor. The additive hydrogen donors can include hydrocarbons and oxy-hydrocarbons having one or more oxygen. Exemplary additive hydrogen donors include, but are not limited to, alkanes, alkenes, alkynes, aldehydes, ketones, ethers, esters, acids, alcohols and glycols, such as, methane, ethane, propane, methyl aldehyde, acetone, acetic acid, ethanol, and glycol. In general, a variety of hydrogen containing compounds can be used, although the use of water or base is generally discouraged. In certain embodiments, the hydrogen donor additive is present such that the ratio of the number of halogen atoms in the organic halide to the number of hydrogen atoms present in both the organic halide and the hydrogen donor is at least 1:1. In certain embodiments, the ratio of the number of halogen atoms in the organic halide to the number of hydrogen atoms present in both the organic halide and the hydrogen donor is between about 1:1 and 1.5:1. In certain embodiments, such as the conversion of R152a (difluoroethane), it is not necessary to include a hydrogen donor as the molecule itself has more hydrogen atoms than halogen atoms.

The reaction of the organic halide and the additive hydrogen donor produces a product stream that includes a hydrogen halide and carbon oxide. The hydrogen halide is an important product resulting from the pyrolytic conversion of organic halides as either a product stream or as an intermediate to other chemical compounds. For example, in certain embodiments, a mineral oxide can be contacted with the product stream to react with the hydrogen halide to produce a mineral halide, which has commercial value. Exemplary mineral oxides suitable for reaction with the hydrogen halide include alumina and calcium oxide. The reaction of hydrogen halide and mineral oxide produces a mineral halide and water.

The reaction for converting the organic halide can take place in the reaction zone of a thermochemical (or thermoconversion) reactor, wherein the reaction zone is maintained at a temperature that is greater than the critical temperature of the organic halide. In certain embodiments, the reaction temperature is maintained at a temperature that is substantially greater than the critical temperature of the organic halide. It is believed that at temperatures above the critical temperature, particularly temperatures substantially greater than the critical temperature, the molecules are generally less stable and therefore more reactive. The approximate temperature of the reaction zone is a function of the critical temperature of the organic halide and a factor z, wherein z is based in part on the number of fluorine atoms present in the organic halide, and can be expressed in mathematical terms as follows: the reaction temperature in the reaction zone (T_{z}) is calculated by using a correlation in which T_{z} is a function of the critical temperature (T_{C}) of the organic halide or organic halide mixture, elevated to an exponent z, wherein equation 1 is defined as

T_{z}=(T_{C})^{z} (1)

wherein the exponent z is derived from an analogue expression to equation 1.

The analogue expression to equation 1 is equation 2, wherein equation 2 is defined as

T_{H}=(T_{C})^{H} (2)

wherein T_{H} is the auto ignition temperature of the additive hydrogen donor, or average auto ignition temperature of a group of hydrogen donors. T_{H} is a function of the T_{C} of the organic halide or organic halide mixture, and exponent H varies with the critical temperature to, in certain embodiments, maintain the T_{H} of the additive hydrogen donor constant.

The value of exponent Z is equation 3,

Z=H+[(F+1)/(C+1)][(Tₕₕ−T_{C})/(TₕₕMₕₕ)] (3)

wherein F represents the number of fluorine atoms present in the organic halide, C represents the number of carbon atoms present in the organic halide molecule, Tₕₕ represents the critical temperature the hydrogen halide product of the reaction, and Mₕₕ, represents the molecular weight of the hydrogen halide product of the reaction. In embodiments wherein a mixture of organic halide or refrigerant fluids are to be treated according to the present invention, the number of fluorine and carbon atoms are averaged, based upon the molar ratio. The constant H is calculated using equation 4, which is defined as

H=ln(T_{H})/ln(T_{C}) (4)

wherein In is the natural logarithm.

The calculated temperature (T_{z}) of the initiation reaction in the reaction zone is obtained by carry out the following steps: (1) selecting the hydrogen donor additive and determining the auto-ignition temperature T_{H} for the hydrogen donor additive; (2) selecting the organic halide and determining the critical temperature T_{C}; (3) calculating H from the equation 4 (i.e., H=ln(T_{H})/ln(T_{C}); (4) calculating Z from equation 3 (i.e., Z=H+[F+1)/(C+1)][(Tₕₕ−T_{C})/(TₕₕMₕₕ)]; and (5) calculating T_{z} from the equation 1 (i.e., T_{Z}=(T_{C})^{Z}). All calculation using the equations provided herein are calculated using temperatures provided in absolute temperature.

In certain embodiments, H can be between about 0.75 and 2, preferably between about 1 and 1.5. The critical temperature of the organic halide or organic halide mixture, in certain embodiments, is typically greater than about −250° C., preferably greater than about −200° C. In certain embodiments, the auto ignition temperature of the additive hydrogen donor is between about 50° C. and about 700° C., preferably between about 125° C. and about 625° C. The temperature of the reaction zone is, in certain embodiments, maintained at a temperature of at least about 350° C., preferably between about 400° C. and about 1000° C., more preferably between about 425° C. and about 925° C. In certain embodiments, the temperature of the reaction zone is maintained at a temperature of between about 450° C. and about 900° C.

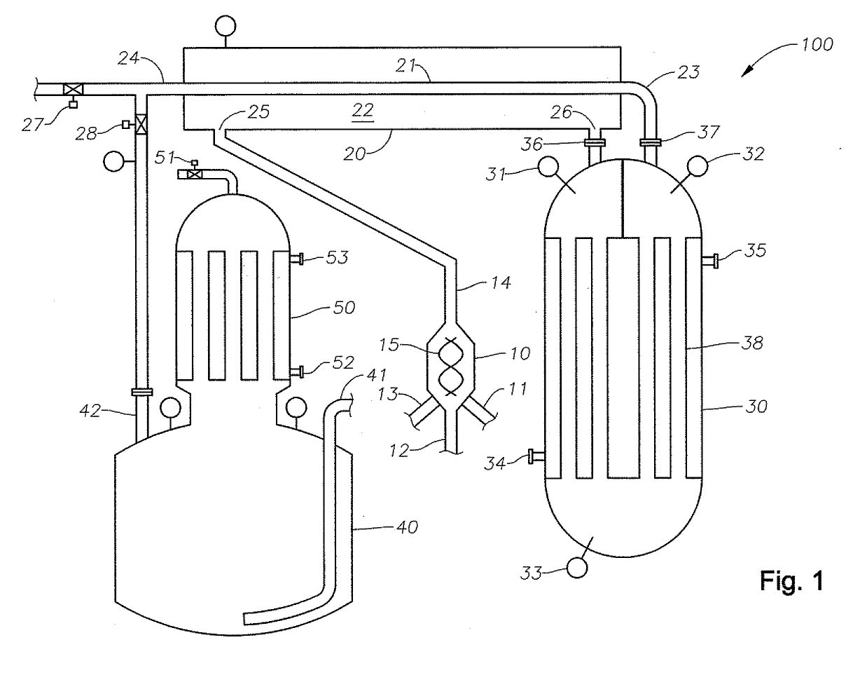

In another aspect, the present invention provides an apparatus for the conversion of organic halides, such as refrigerant fluids, to hydrogen halides and carbon oxides. In certain embodiments, the conversion is achieved in the absence of a catalyst. In certain embodiments, the conversion of the organic halide is achieved in the absence of a metal catalyst. Referring now to FIG. 1, an exemplary representation of one embodiment of apparatus 100 is provided. Apparatus 100 is suitable for conducting non-adiabatic thermochemical conversion of organic halide compounds, such as refrigerant fluids, to hydrogen halide compounds and carbon oxide. The apparatus 100, which includes multiple interconnected pieces, such as piping, valves, sensors and the like, can be constructed of stainless steel, Hastelloy, Monel, Inconel, nickel, or a like material capable of operating at the temperatures and pressures contemplated herein. Preferred materials of construction include Monel 400 and/or Nickel 200. Apparatus 100 can include gas homogenizer 10, energy economizer heat exchanger 20, reaction chamber 30, hydrogen halide liquid receiver 40, and reflux condenser 50. Additionally, apparatus 100 can include a scrubber for the neutralization of the hydrogen halide product, an auxiliary air blower, an auxiliary solid reaction vessel, and process controllers. Homogenizer 10 can be constructed from a metal, such as carbon steel, stainless steel, Monel, nickel, nickel alloys, or the like. The diameter of homogenizer 10 can be between approximately 2.5 cm and 250 cm, and the height can be between approximately 25 cm and 250 cm.

Homogenizer 10 can be any shape, and is preferably a cylindrical metallic vessel, and can be equipped with entrance ports 11, 12, and 13 for the introduction of one or more fluids, such as the organic halide or waste refrigerant, the additive hydrogen donor, and the oxygen carrier. Homogenizer 10 can also include internal mixer 15, and the mixed gases exit the homogenizer via port/strainer 14. The strainer ensures that only gaseous materials pass from the mixer into the reaction chamber 30.

Organic halide fluids can be supplied to homogenizer 10 via organic halide entrance port 11. Hydrogen donor additive is supplied to homogenizer 10 via additive entrance port 13. Entrance ports 11, 12 and 13 are connected to homogenizer 10 and can be made of steel, stainless steel, Inconel, Monel, nickel, or like material capable of operating at the temperatures and pressures contemplated herein. The oxygen carrier can be supplied to homogenizer 10 via oxygen carrier entrance port 12. In certain embodiments, the organic halide, the hydrogen donor additive, and the oxygen carrier are each introduced into homogenizer 10 simultaneously. The organic halide, additive, and oxygen carrier are mixed with static mixer 15 to create a gas mixture, exit homogenizer 10 via homogenizer exit 14, and flow into heat exchanger 20, wherein the temperature of the gas mixture increases from room temperature to close to the reaction temperature. Heat exchanger 20 can include concentric counter inner flow tube 21 and concentric counter outer flow tube 22. The gas mixture enters heat exchanger via heat exchanger inlet 25, is heated, and is then supplied to conversion reactor 30 via heat exchanger outlet 26. The gas mixture exits heat exchanger 20 and enters conversion reactor 30 reaction zone via entry port 26, which is connected to reactor 30 by pipe flanges 36. Within conversion reactor 30, the hydrogen donor additive reacts with the organic halide to produce hydrogen halide products. The reaction between the organic halide and hydrogen donor additive to form the hydrogen halide is exothermic, and it is controlled by the heat transfer through diathermal walls 38 of conversion reactor 30. The rate of conversion of the organic halide can be between about 0.5 and 1.5 lb/hr per 100 square inches of diathermal wall, preferably between about 0.75 and 1.25 lb/hr per 100 square inches of diathermal wall. If the temperature increases above the reaction temperature as a consequence of the exothermic reaction, the heat from reaction zone will be removed. In certain embodiments, the conversion reactor does not include a plasma energy source. Port 34 and port 35 of conversion reactor 30 are inlet and outlet ports, respectively, for the circulation of the heat transfer medium for controlling the temperature within the reaction zone. Temperature sensors 31, 32, 33 provide measurements of the temperature within conversion reactor 30 to the process controller (not shown). The process controller regulates the flow of heat transfer medium through inlet 34 and outlet 35 to maintain the reaction temperature within the reaction zone within a pre-determined range. In certain embodiments, the heat transfer medium can be air, which is supplied by an air blower (not shown), which can be coupled to the controller, in an effort to maintain the temperature within the conversion reactor at the set temperature. Alternatively, the heat transfer medium can be a liquid that is circulated through the reaction zone.

The blower assembly for supplying the air heat transfer medium can include a blower, a blower motor, and an inlet air cleaner tank. Preferably, the blower assembly also includes an air silencer tank. A wet scrubber (not shown) can be a vertical vessel made of metal such as steel, stainless steel, Monel, Inconel, nickel, or a like material capable of the operating at the temperatures and pressures described herein. The wet scrubber can be a vertical vessel having a diameter of between about 40 cm and 400 cm, and a height of between about 1 m to 10 m, although it is understood that larger and smaller dimensions are also possible. The wet scrubber can further include a mixer, a motor, a top loading connection, a drain valve, a gas valve inlet and a gas outlet.

Any impermeable metallic wall that can transfer heat through the metallic wall is a diathermal wall and is part of the diathermal wall 38. Any impermeable metallic wall in reactor 30 that is in contact with the reactant is part of the reaction zone in the reactor. The heat transfer medium supplied via inlet port 34 can be used initially to heat the reaction zone of the conversion reactor 30. As the reaction progresses, the heat produced by the exothermic reaction of the organic halide and the hydrogen donor additive causes the temperature of the reaction zone to be increase to greater than the reaction temperature set point. This is facilitated by temperature sensors 31, 32 and 33. The measured temperature(s) in the reaction zone are then supplied from temperature sensors 31, 32 and 33 to the controller, which, upon noting that the temperature is greater than the desired temperature, can provide instruction for the cooling of the reaction zone. In certain embodiments, the conversion reactor 30 is cooled using the air blower. Alternatively, the conversion reactor 30 is cooled by closing solenoid valves (not shown) to stop the flow of the organic halide and the hydrogen donor additive to mixer 10. In yet other embodiments, the air blower can be used in combination with closing solenoid valves to cool the reaction zone. The heat created by the exothermic reaction can be transferred by conduction through the wall thickness of the diathermal wall 38 and the pipe elements in the reaction zone.

The hydrogen halide and carbon oxide exit reactor 30 via line 23, which is connected to the reactor by flange 37, and is transferred via concentric counter inner flow tube 21 of heat exchanger 20 to line 24. Line 24 can supply the hydrogen halide and carbon oxide to hydrogen halide liquid receiver 40 via line 42. Lines 24 and 42 can include one or more valves 27, 28 that can be used to control to flow of the product stream.

Hydrogen halide liquid receiver 40 is a receiver vessel where the hydrogen halide, preferentially hydrofluoric acid, can be collected. Hydrogen halide liquid receiver 40 can be constructed of steel, stainless steel, Hastelloy, Monel, Inconel, nickel, or a like material capable of operating at the temperatures and pressures contemplated herein. Reflux condenser 50 is integrated into and a part of hydrogen halide liquid receiver 40, and can similarly be constructed of steel, stainless steel, Hastelloy, Monel, Inconel, nickel, or a like material capable of operating at the temperatures and pressures contemplated herein. A cooling medium can be introduced into reflux condenser 50 can be circulated via inlet 52 and outlet 53. The temperature of the cooling medium can be maintained at a temperature that is approximately 20° C. less than the boiling point of the hydrogen halide fluid. The hydrogen halide fluid from heat exchanger 20 can be introduced the combination hydrogen halide liquid receiver 40 and condenser 50 via port 42. Any fluids exiting condenser 50 can then be introduced to a scrubber (not shown) via line 51. The scrubber can be charged with a base, such as NaOH, KOH, CaO, Ca(OH)₂, or the like, for the removal of the hydrogen halide acid or carbon dioxide reaction product. After absorption of the hydrogen halide acid or carbon dioxide reaction product with the scrubber, residual gases are exhausted and tested to determine if any refrigerant remains, giving an indication of complete or incomplete destruction of the organic halide.

In certain embodiments, liquid receiver 40 can include means for heating the hydrogen halide product stream, such as a heating mantle, external heating tape, hot plate, or a like apparatus, to assist in the separation of various compounds. In certain embodiments having mixed hydrogen halides, such as for example, a mixture that includes hydrofluoric acid and hydrochloric acid, the products can be separated by distillation. In certain embodiments, the hydrogen halide product can be diluted with water. A product stream of the hydrogen halide can be removed from liquid receiver 40 via line 41.

In general, the reaction of the organic halide and the hydrogen donor is conducted at relatively low pressures. In certain embodiments, the reaction is carried out at pressures up to about 25 psi, preferably at pressures up to about 15 psi. In certain embodiments, the reaction is carried out at atmospheric pressure.

In addition to the process equipment shown in FIG. 1, other components can also be added to apparatus 100. In certain embodiments, a neutralization scrubber can be added wherein hydrogen halides exiting reactor 30 can be contacted with a base, such as NaOH, KOH, or the like, to neutralize the acids produced. Alternatively, apparatus 100 can include a solid reaction vessel charged with a mineral oxide, such as for example, alumina. Contacting the mineral oxide with the hydrogen halide stream can produce a mineral halide. For example, contacting alumina with hydrofluoric acid can produce aluminum fluoride, which can then be collected. In certain embodiments, the step of contacting the hydrogen halide steam with the mineral oxide is at room temperature. In alternate embodiments, the step of contacting the hydrogen halide stream is at a temperature of up to about 500° C. Alternatively, the step of contacting the hydrogen halide stream is at a temperature of between about 250° C. and 450° C.

### EXAMPLES

The following reactions represent typical conversion reactions in which various illustrative refrigerant fluids are thermochemically converted into hydrogen halide.

### Example 1

Conversion of R116 (hexafluoroethane). Hexafluoroethane, ethane, and oxygen were mixed to form a gas mixture, which was then supplied to the conversion reactor at a rate of 15 g/hour. The conversion reactor was maintained at a temperature of about 709° C. The reaction was conducted for approximately 8 hours, and produced hydrofluoric acid, carbon dioxide and heat, with no traces of organic halide present.

### Example 2

R14 (carbon tetrafluoride). Carbon tetrafluoride, methane and oxygen were mixed and were mixed to form a gas mixture, which was then supplied to the conversion reactor at a rate of 20 g/hour. The conversion reactor was maintained at a temperature of about 931°. The reaction was conducted for approximately 4 hours, and produced hydrofluoric acid, carbon dioxide and heat, with no traces of organic halide present.

### Example 3

R116 (hexafluoroethane). Hexafluoroethane, propane and oxygen were mixed and were mixed to form a gas mixture, which was then supplied to the vertically positioned conversion reactor having an outer diameter of about 33 mm, an inner diameter of about 25 mm, and a length of about 150 cm. A ceramic insulated heater (capacity of approximately 7.2 kW) was installed around the exterior surface of the above described reactor for supplying heat to the walls of the reactor. The reactor included two thermocouples, one on the outer surface of the reactor, and the other positioned within the reaction zone, approximately 40 cm from the bottom of the reactor. The thermocouple is further coupled to a controller, which is coupled to the ceramic heater, and which is designed to maintain a constant temperature within the reaction zone of the conversion reactor.

The hexafluoroethane was supplied to the conversion reactor at a rate of about 69 g/hour, the propane was supplied to the conversion reactor at a rate of about 33 g/hour, and air was supplied to the conversion reactor at a rate of about 6 L/minute. The calculated reaction zone temperature was about 709° C. The conversion reactor was maintained at a temperature of between about 685° C. and 735° C. The reaction was conducted for approximately 5 hours, and produced hydrofluoric acid, carbon dioxide and heat. The gases exiting the reactor were monitored and no hexafluoroethane was detected.

### Example 4

R14 (tetrafluoromethane). Tetrafluoromethane, propane and oxygen (air) were supplied to the testing apparatus described in Example 3. The tetrafluoromethane was supplied to the conversion reactor at a rate of about 53 g/hour, the propane was supplied to the conversion reactor at a rate of about 26 g/hour, and air was supplied to the conversion reactor at a rate of about 6 L/minute. The calculated reaction zone temperature was about 927° C. The conversion reactor was maintained at a temperature of between about 900° C. and 960° C. The reaction was conducted for approximately 5 hours, and produced hydrofluoric acid, carbon dioxide and heat. The gases exiting the reactor were monitored and no tetrafluoromethane was detected.

### Example 5

R134a (tetrafluoroethane). Tetrafluoroethane, propane, and oxygen (air) were supplied to the testing apparatus described in Example 3. The tetrafluoroethane was supplied to the conversion reactor at a rate of about 60 g/hour, the propane was supplied to the conversion reactor at a rate of about 20 g/hour, and air was supplied to the conversion reactor at a rate of about 6 L/minute. The calculated reaction zone temperature was about 675° C. The conversion reactor was maintained at a temperature of between about 564° C. and 604° C. The reaction was conducted for approximately 5 hours, and produced hydrofluoric acid, carbon dioxide and heat. The gases exiting the reactor were monitored and no tetrafluoroethane was detected.

### Example 6

Mixture of refrigerants: R-14, R-23, R-32, R-125, R-134a, R-22 and R-12. A mixture of refrigerants, including tetrafluoromethane, trifluorohydromethane, difluorodihydromethane, R125, R134a and difluorochlorohydromethane were supplied to a process apparatus, along with propane and oxygen (air). The gaseous mixture was supplied to a mixing apparatus, and were then supplied to a reaction zone. The mixed refrigerant gasses were supplied at a rate of about 15 lbs/hour, the propane was added at a rate of about 3 lbs/hour, and the oxygen was supplied at a rate of about 15 cfm. The conversion reactor was maintained at a temperature of between about 700° C. and 800° C. for approximately 10 hours, and produced hydrofluoric acid, hydrogen chloride, carbon dioxide and heat. The gases exiting the reactor were monitored and no refrigerants were detected.

The resulting hydrogen fluoride and hydrogen chloride were supplied to a solid reactor charged with approximately 100 lbs of alumina. After the reaction with the alumina, the solid weight was approximately 151 lbs, corresponding to the incorporation of approximately 88 lbs of fluorine. Chlorine from the hydrochloric acid passes through the solid reactor and can be subsequently removed with a scrubber.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

1. A method for treating organic halides, comprising the steps of:
contacting an organic halide, and a hydrogen donor in a catalyst free reaction zone, wherein the catalyst free reaction zone is maintained at a reaction zone temperature that is greater than the critical temperature of the organic halide;
collecting a product stream consisting of hydrogen halide and carbon oxide.

2. The method of claim 1 further comprising the step of supplying the hydrogen halide stream to a second reactor charged with a solid adsorbent material, said adsorbent material being operable to react with the hydrogen halide, such that the halide is adsorbed onto the solid adsorbent material.

3. The method of claim 1 further comprising the step of supplying the hydrogen halide stream to a second reactor charged with a mineral oxide, said adsorbent material being operable to react with the hydrogen halide, such that the halide is adsorbed onto the solid adsorbent material.

4. The method of claim 1 further comprising contacting the organic halide and hydrogen donor with an oxygen source.

5. The method of claim 4 wherein the ratio of halogen atoms present in the organic halide and hydrogen atoms present in the organic halide and hydrogen donor is at least 1:1.

6. The method of claim 1 wherein the hydrogen donor is selected from the group consisting of methane, ethane, ethene, and propane.

7. The method of claim 1 wherein the hydrogen donor is selected from the group consisting of aldehydes, ketones, ethers, esters, carboxylic acids, alcohols, and glycols.

8. The method of claim 4 wherein the oxygen source is air.

9. The method of claim 1 wherein the reaction zone is maintained at a reaction zone temperature of between about 400 and 1000° C.

10. The method of claim 1 wherein the reaction zone is maintained at a reaction zone temperature of between about 425 and 925° C.

11. (canceled)

12. (canceled)

13. (canceled)

14. (canceled)

15. (canceled)

16. A method for treating organic halides, comprising the steps of:
supplying a mixture consisting of an organic halide and a organic hydrogen donor to a reaction zone to produce a product stream, wherein the reaction zone is maintained at a reaction zone temperature that is greater, than the critical temperature of the organic halide;
collecting the product stream that consists of hydrogen halide and carbon oxide.

17. The method of claim 16 further comprising the step of supplying the product stream to a second reactor, wherein the second reactor is charged with a solid adsorbent material, said adsorbent material being operable to react with the hydrogen halide, such that the hydrogen halide is adsorbed onto the solid adsorbent material.

18. The method of claim 16 further comprising the step of supplying the product stream to a second reactor, wherein the second reactor is charged with a mineral oxide, said mineral oxide being operable to react with the hydrogen halide to produce a mineral halide.

19. The method of claim 16 wherein the gas mixture further consists of an oxygen carrier.

20. The method of claim 19 wherein the ratio of halogen atoms present in the organic halide and hydrogen atoms present in the organic halide and hydrogen donor is at least 1:1.

21. The method of claim 16 wherein the hydrogen donor is a hydrocarbon selected from the group consisting of methane, ethane, ethene, and propane.

22. The method of claim 16 wherein the hydrogen donor is an oxy-hydrocarbon.

23. The method of claim 16 wherein the reaction zone is maintained at a reaction zone temperature of between about 400° C. and 1000° C.

24. The method of claim 16 wherein the reaction zone is catalyst free.

25. A method for treating organic halides, comprising the steps of:
contacting an organic halide, and a hydrogen donor in a catalyst free reaction zone, wherein the catalyst free reaction zone is maintained at a reaction zone temperature that is greater than the critical temperature of the organic halide;
collecting a product stream comprising anhydrous hydrogen halide and carbon oxide.
